(19) United States
(12) Patent Application Publication
(10) Pub. No.: US 2026/0086914 A1
(43) Pub. Date: Mar. 26, 2026

(54) Evaluating Performance Impact of Tracers on Applications

(71) Applicant: International Business Machines Corporation, Armonk, NY (US)

(72) Inventors: Hui Gao, Beijing (CN); Hai Jun Xu, Beijing (CN); Yanfeng Shi, Beijing (CN); Huai Nan Zhou, Beijing (CN); Yue Chen, Beijing (CN); Yue Wang, Beijing (CN)

(21) Appl. No.: 18/892,945

(22) Filed: Sep. 23, 2024

(51) Int. Cl. G06F 11/34

(52) U.S. Cl. CPC G06F 11/3471; G06F 11/3433

(57) ABSTRACT

Identifying performance impact of tracers on applications is provided. A comparison of a first profile corresponding to a first instance of two instances of a service with a first tracer enabled and a second profile corresponding to a second instance of the two instances of the service with a second tracer disabled is performed. A method of the service impacted by the first tracer causing a performance issue is identified based on the comparison of the first profile corresponding to the first instance of the two instances of the service with the first tracer enabled and the second profile corresponding to the second instance of the two instances of the service with the second tracer disabled.

### BACKGROUND

The disclosure relates generally to application profiling and tracing and more specifically to evaluating performance impact of tracers on applications.

Application profiling is a process that involves monitoring the performance of an application under various scenarios and conditions. Profiling helps developers to understand the behavior of the application under load and identify areas for improvement. For example, profiling captures a snapshot of resource usage (e.g., central processing unit (CPU) usage, memory usage, storage usage, network usage, and the like) and maps the resource usage to lines of code. In addition, profiling identifies execution times of specific methods to provide detailed insight into how the application is performing. The goal of profiling is to optimize the application to improve speed, responsiveness, and resource consumption.

Application tracing tracks the flow and timing of service requests as the service requests pass through the system, which helps developers to identify bottlenecks. A trace is a log of events that occurred during execution of the application. By tracing a service request from the frontend to the backend, and back again, developers obtain insight into which services are involved with the service request and how long the services take to respond. In other words, tracing can track the flow of each service request through various services corresponding to the application to pinpoint delays. As a result, tracing can identify and measure slowdowns or bottlenecks.

### SUMMARY

According to one illustrative embodiment, a method is provided. A comparison of a first profile corresponding to a first instance of two instances of a service with a first tracer enabled and a second profile corresponding to a second instance of the two instances of the service with a second tracer disabled is performed. A method of the service impacted by the first tracer causing a performance issue is identified based on the comparison of the first profile corresponding to the first instance of the two instances of the service with the first tracer enabled and the second profile corresponding to the second instance of the two instances of the service with the second tracer disabled. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIGS. 2A-2B are a diagram illustrating an example of a tracer performance impact analysis system in accordance with an illustrative embodiment;

FIG. 3 is a diagram illustrating an example of a tracer performance driver sequence diagram in accordance with an illustrative embodiment;

FIG. 4 is a diagram illustrating an example of critical path analyzer data in accordance with an illustrative embodiment;

FIG. 5 is a diagram illustrating an example of a critical path analyzer process in accordance with an illustrative embodiment;

FIG. 6 is a diagram illustrating an example of a tracer operator process in accordance with an illustrative embodiment;

FIG. 7 is a diagram illustrating an example of a policy definer process in accordance with an illustrative embodiment;

FIG. 8 is a diagram illustrating an example of a policy definer rule in accordance with an illustrative embodiment; and

FIGS. 9A-9C are a flowchart illustrating a process for analyzing tracer impact on applications in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

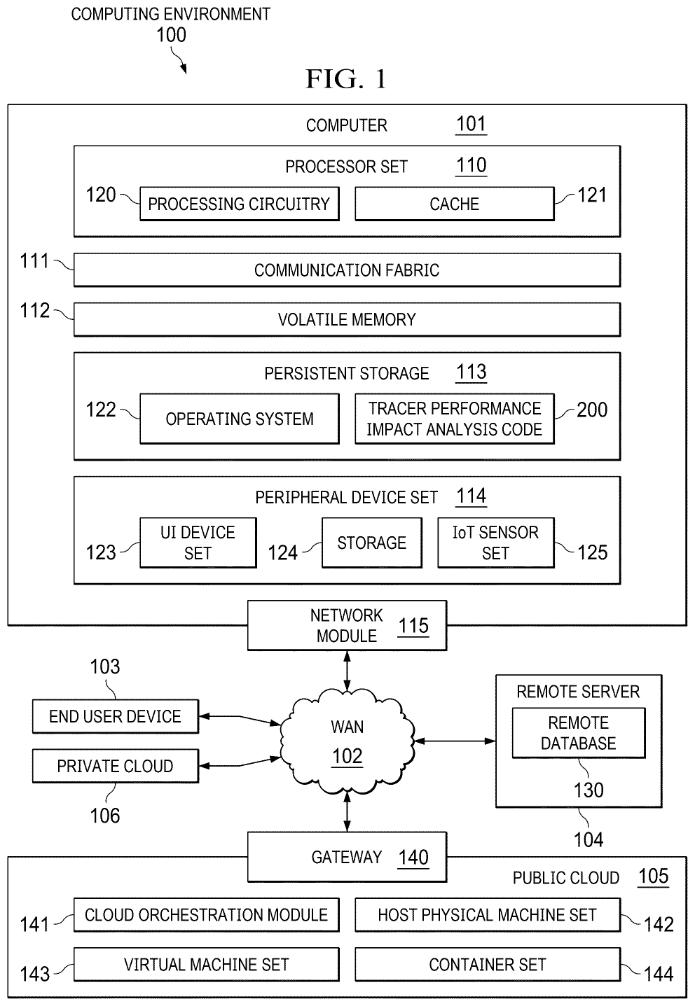

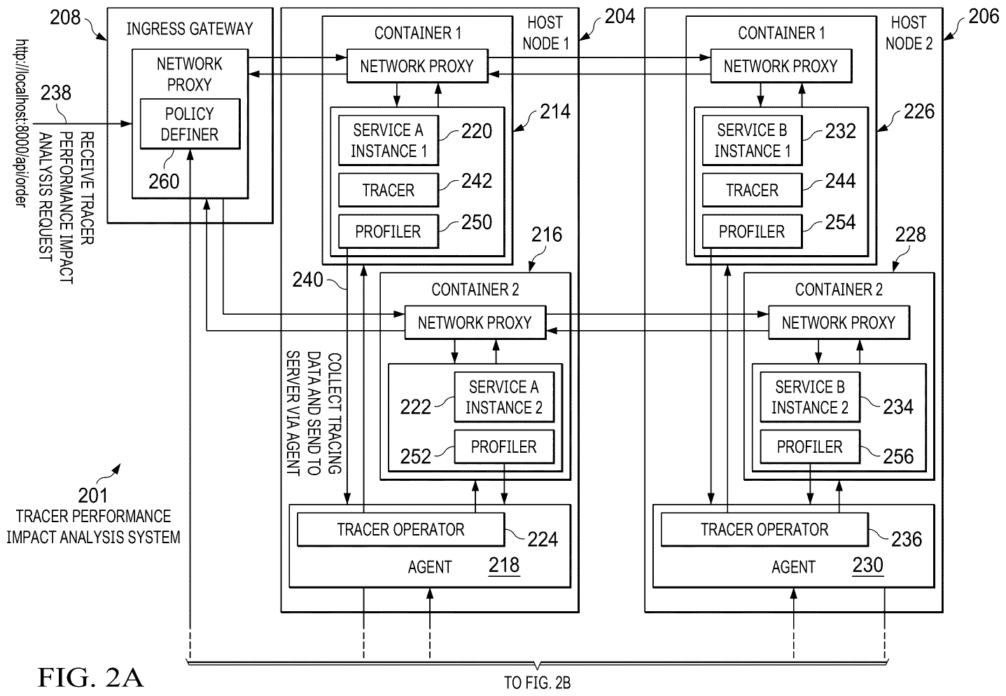

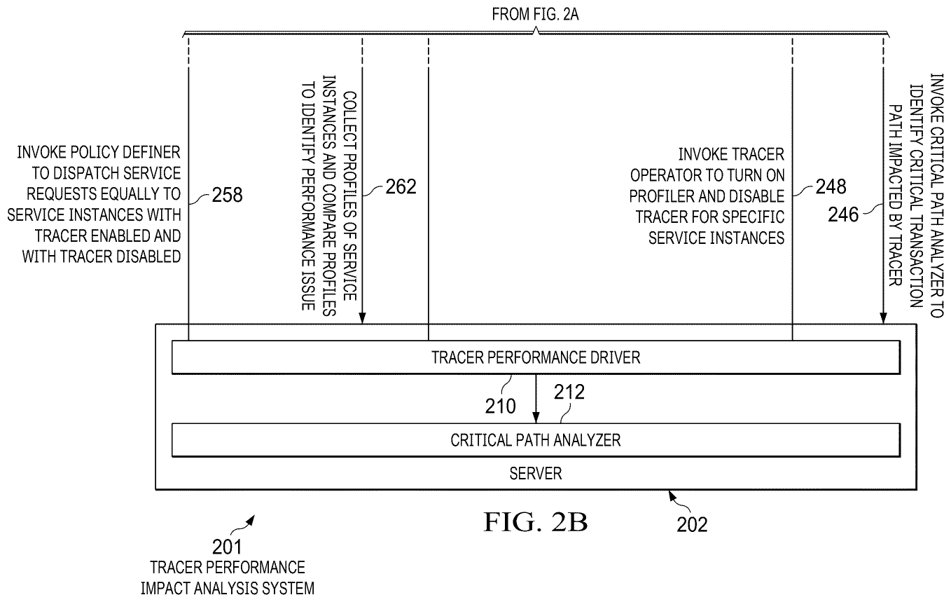

With reference now to the figures, and in particular, with reference to FIG. 1 and FIGS. 2A-2B, diagrams of data processing environments are provided in which illustrative embodiments may be implemented. It should be appreciated that FIG. 1 and FIGS. 2A-2B are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based cloud environment for the execution of at least some of the computer code involved in performing the inventive methods of illustrative embodiments, such as tracer performance impact analysis code 200.

For example, tracer performance impact analysis code 200 evaluates the performance impact of observability product tracers on applications, such as, for example, distributed or containerized cloud applications. Tracer performance impact analysis code 200 utilizes a tracer performance driver located in computer 101 to control and manage a critical path analyzer, tracer operator, and policy definer to collect profiles of an application with and without tracers enabled. Then, tracer performance impact analysis code 200 utilizes the tracer performance driver to compare the collected application profiles, one profile with the tracer enabled and one profile with the tracer disabled, to identify the application performance issue (e.g., bottleneck) caused by the tracer.

For example, in response to a user requesting a tracer performance impact analysis, the tracer performance driver invokes the critical path analyzer. The critical path analyzer receives as input, for example, topology of the application, service and infrastructure mapping data corresponding to the application, end user monitoring data corresponding to the application, performance issue data corresponding to the application, and the like. End user monitoring data is information about how users interact with the application online. The critical path analyzer analyzes the topology, service and infrastructure mapping data, end user monitoring data, and the performance issue data corresponding to the application to identify a critical transaction path in the application. The critical transaction path contains a set of service nodes within the topology related to the performance issue caused by the tracer. The critical path analyzer returns the most impacted service in the topology and the corresponding service request as output.

Subsequently, the tracer performance driver uses the output of the critical path analyzer to invoke the tracer operator to enable and disable the tracers corresponding to the service instances of the application. For example, the tracer operator enables a tracer for one of the service instances being profiled and disables a tracer for the other service instance being profiled for future profile comparison.

The tracer performance driver utilizes the policy definer to generate rules for dispatching the same number of service requests with equal weight to each of the two service instances so that each service instance processes or executes the same workload for profiling purposes. In addition, the policy definer dispatches the service requests to the two service instances in accordance with the defined rules.

The tracer performance driver collects the profiles corresponding to the two service instances from the tracer operator located in the host node. The tracer performance driver compares the two different profiles of the two service instances, one service instance with the tracer enabled and one service instance with the tracer disabled, to determine the central processing unit (CPU) intensive method (e.g., process or the like) of the service causing the performance issue bottleneck created by the tracer.

In addition to tracer performance impact analysis code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and tracer performance impact analysis code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in tracer performance impact analysis code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., an application developer who utilizes the tracer performance impact analysis services provided by computer 101), and may take any of the forms discussed above in connection with computer 101. EUD 103 typically receives helpful and useful data from the operations of computer 101. For example, in a hypothetical case where computer 101 is designed to provide a tracer performance impact analysis to the end user, this analysis would typically be communicated from network module 115 of computer 101 through WAN 102 to EUD 103. In this way, EUD 103 can display, or otherwise present, the tracer performance impact analysis to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a tracer performance impact analysis based on historical data, such as, for example, application topology data, end user monitoring data, service and infrastructure mapping data, performance issue data, and the like, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In a cloud environment, such as a container-based cloud environment (e.g., Kubernetes® a registered trademark of the Linux Foundation of San Francisco, California, USA), distributed services provided by an application are typically large, complex, and increasingly built upon other similarly complex distributed services. Tracers (e.g., observability products and the like) are widely used to provide insights into these applications. For example, tracers are used to capture transaction data in these applications. Tracers are usually instrumented into an application, which increases application overhead. In addition, even though performance testing is performed to evaluate application overhead before delivering a tracer, there are several different factors that impact application performance, such as, for example, different environments, untested frameworks, different application workloads, different user scenarios, and the like. Further, when an entity (e.g., an individual, enterprise, company, business, organization, institution, agency, or the like) reports an application performance issue caused by a tracer, it is difficult for the application development team to reproduce and diagnose the performance issue in a lab due to the different factors listed above.

Illustrative embodiments utilize a tracer performance driver to manage the process of evaluating the performance impact of tracers on applications. For example, the tracer performance driver coordinates the operations of a critical path analyzer, tracer operator, and policy definer to collect application profiles with and without tracers enabled, and then compares the profiles to identify any performance issues (e.g., service performance bottlenecks such as increased CPU usage, increased response times, and the like) caused by the tracers. The tracer performance driver utilizes the critical path analyzer to analyze the topology of an application and then identify a critical transaction path in the application. The critical transaction path includes a set of service nodes in the application topology involved with the performance issue (i.e., the most impacted service of the application by the tracer).

The tracer performance driver utilizes the policy definer to dispatch an equal number of service requests to the service instances of the application for profiling purposes. The tracer performance driver utilizes the tracer operator located in the host node to turn on the profilers and enable and disable tracers corresponding to the different service instances of the application. The tracer operator collects the profiling data from one profiler corresponding to one service instance with the tracer enabled and collects the profiling data from the other profiler corresponding to the other service instance with the tracer disabled. Then, the tracer operator sends the two different profiles corresponding to the two different service instances of the application to the tracer performance driver for analysis. The tracer performance driver then compares the two different profiles to identify a process in a service in the critical transaction path causing the performance issue introduced by the tracer. In other words, the tracer performance driver determines which service of the application is most impacted when the tracer is enabled and running. Thus, illustrative embodiments can quickly identify performance issues in services corresponding to applications caused by tracers and thereby accelerate the resolution of these identified performance issues.

Thus, illustrative embodiments provide one or more technical solutions that overcome a technical problem with identification of performance issues in services caused by tracers running in applications. As a result, these one or more technical solutions provide a technical effect and practical application in the field of application development and performance.

With reference now to FIGS. 2A-2B, a diagram illustrating an example of a tracer performance impact analysis system is depicted in accordance with an illustrative embodiment. Tracer performance impact analysis system 201 may be implemented in a computing environment, such as computing environment 100 in FIG. 1. Tracer performance impact analysis system 201 is a system of hardware and software components for identifying a performance issue in a service of an application caused by a tracer running in the application.

In this example, tracer performance impact analysis system 201 includes server 202, host node 1 204, host node 2 206, and ingress gateway 208. Server 202 can be, for example, computer 101 in FIG. 1. Host node 1 204 and host node 2 206 can be, for example, machines in host physical machine set 142 or virtual machine set 143 in FIG. 1. Ingress gateway 208 can be, for example, gateway 140 in FIG. 1. However, it should be noted that tracer performance impact analysis system 201 is intended as an example only and not as a limitation on illustrative embodiments. For example, tracer performance impact analysis system 201 can include any number of servers, host nodes, ingress gateways, and other devices and components not shown.

Server 202 includes tracer performance driver 210 and critical path analyzer 212. Tracer performance driver 210 may be implemented by tracer performance impact analysis code 200 in FIG. 1.

Host node 1 204 includes container 1 214, container 2 216, and agent 218. Container 1 214 and container 2 216 may be, for example, containers in container set 144 in FIG. 1. In this example, container 1 214 runs service A instance 1 220 and container 2 216 runs service A instance 2 222. It should be noted that service A instance 1 220 and service A instance 2 222 are two instances of the same service. Agent 218 includes tracer operator 224 which controls the enablement and disablement of tracers in container 1 214 and container 2 216.

Similarly, host node 2 206 includes container 1 226, container 2 228, and agent 230. Container 1 226 and container 2 228 also may be containers in container set 144 in FIG. 1. In this example, container 1 226 runs service B instance 1 232 and container 2 228 runs service B instance 2 234. It should be noted that service B instance 1 232 and service B instance 2 234 are two instances of the same service. Also, it should be noted that an application, such as, for example, a distributed or containerized cloud application provides service A and service B. Agent 230 includes tracer operator 236 which controls the enablement and disablement of tracers in container 1 226 and container 2 228.

However, it should be noted that host node 1 204 and host node 2 206 are intended as examples only and not as limitations on illustrative embodiments. For example, host node 1 204 and host node 2 206 may include any number of containers. Further, each container may run any number of service instances. For example, a container may run only one instance of a service, two instances of the same service as shown above, or more than two instances of the same service. If a container is running only one instance of a service, then the tracer operator of that host node can adjust the deployment to have at least two instances of that same service running on the container for comparison purposes.

At 238, ingress gateway 208 receives a tracer performance impact analysis request from a user, such as an application developer, system administrator, or the like. At 240, tracers, such as tracer 242 corresponding to service A instance 1 220 and tracer 244 corresponding to service B instance 1 232, collect tracing data and send the tracing data to server 202 via agent 218 of host node 1 204 and agent 230 of host node 2 206.

At 246, tracer performance driver 210 invokes critical path analyzer 212 to identify a critical transaction path that includes a service impacted by a tracer. At 248, tracer performance driver 210 invokes tracer operator 224 to turn on profiler 250 to profile service A instance 1 220 and profiler 252 to profile service A instance 2 222 and disable the tracer for service A instance 2 222. In addition, tracer performance driver 210 invokes tracer operator 236 to turn on profiler 254 to profile service B instance 1 232 and profiler 256 to profile service B instance 2 234 and disable the tracer for service B instance 2 234.

At 258, tracer performance driver 210 invokes policy definer 260 of ingress gateway 208 to dispatch service requests equally to service A instance 1 220 with tracer 242 enabled while profiler 250 is profiling service A instance 1 220 and service A instance 2 222 with the tracer disabled while profiler 252 is profiling service A instance 2 222. Also, tracer performance driver 210 invokes policy definer 260 to dispatch service requests equally to service B instance 1 232 with tracer 244 enabled while profiler 254 is profiling service B instance 1 232 and service B instance 2 234 with the tracer disabled while profiler 256 is profiling service B instance 2 234.

At 262, tracer performance driver 210 collects the profiles of service A instance 1 220 with tracer 242 enabled and service A instance 2 222 with the tracer disabled while processing an equal number of service requests (i.e., the same workload). After collecting the profiles of service A instance 1 220 with tracer 242 enabled and service A instance 2 222 with the tracer disabled, tracer performance driver 210 compares the two profiles to identify any performance issues caused by tracer 242. Similarly, tracer performance driver 210 collects the profiles of service B instance 1 232 with tracer 244 enabled and service B instance 2 234 with the tracer disabled while processing an equal number of service requests. After collecting the profiles of service B instance 1 232 with tracer 244 enabled and service B instance 2 234 with the tracer disabled, tracer performance driver 210 compares the two profiles to identify any performance issues caused by tracer 244.

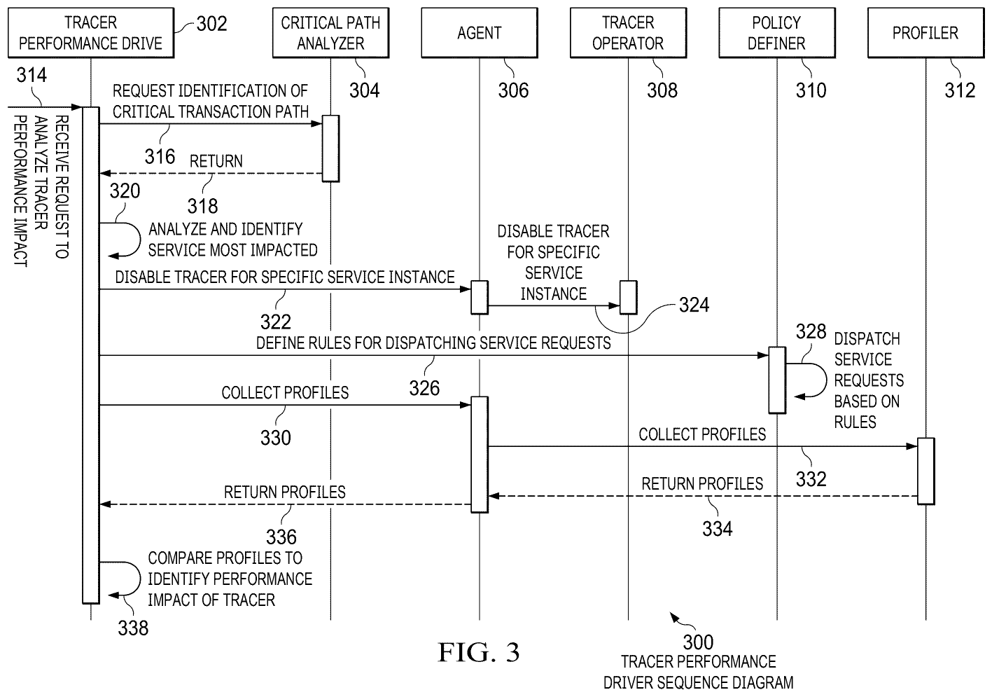

With reference now to FIG. 3, a diagram illustrating an example of a tracer performance driver sequence diagram is depicted in accordance with an illustrative embodiment. Tracer performance driver sequence diagram 300 may be implemented in tracer performance impact analysis system 201 in FIGS. 2A-2B. For example, tracer performance driver sequence diagram 300 is implemented by tracer performance driver 302, critical path analyzer 304, agent 306, tracer operator 308, policy definer 310, and profiler 312, such as tracer performance driver 210, critical path analyzer 212, agent 218, tracer operator 224, policy definer 260, and profiler 250 in FIGS. 2A-2B.

In this example, tracer performance driver sequence diagram 300 starts at 314 where tracer performance driver 302 receives a request to analyze tracer performance impact on a service of an application. At 316, tracer performance driver 302 requests critical path analyzer 304 to identify a critical transaction path in the application. At 318, critical path analyzer 304 returns the critical transaction path to tracer performance driver 302. At 320, tracer performance driver 302 analyzes the critical transaction path to identify the service in the critical transaction path most impacted.

At 322, tracer performance driver 302 directs agent 306 to disable the tracer for a specific service instance, such as service A instance 2 222 of FIG. 2A. In turn, at 324, agent 306 instructs tracer operator 308 to disable the tracer for that specific service instance while processing the same workload as another instance of the same service, such as service A instance 1 220, with the tracer enabled, such as tracer 242 in FIG. 2A.

At 326, tracer performance driver 302 directs policy definer 310 to define rules for dispatching service requests equally to the two instances of the same service. At 328, policy definer 310 dispatches the service requests equally to the two instances of the same service based on the rules.

At 330, tracer performance driver 302 directs agent 306 to collect profiles of the two instances of the same service, one service instance with the tracer enabled and the other service instance with the tracer disabled. In turn, at 332, agent 306 instructs profiler 312 to collect the profiles of the two instances of the same service processing the same workload.

At 334, profiler 312 returns the profiles of the two instances of the same service processing the same workload to agent 306. At 336, agent 306 returns the profiles of the two instances of the same service processing the same workload to tracer performance driver 302. At 338, tracer performance driver 302 compares the two profiles to identify any performance impact on the service instance with the tracer enabled and running.

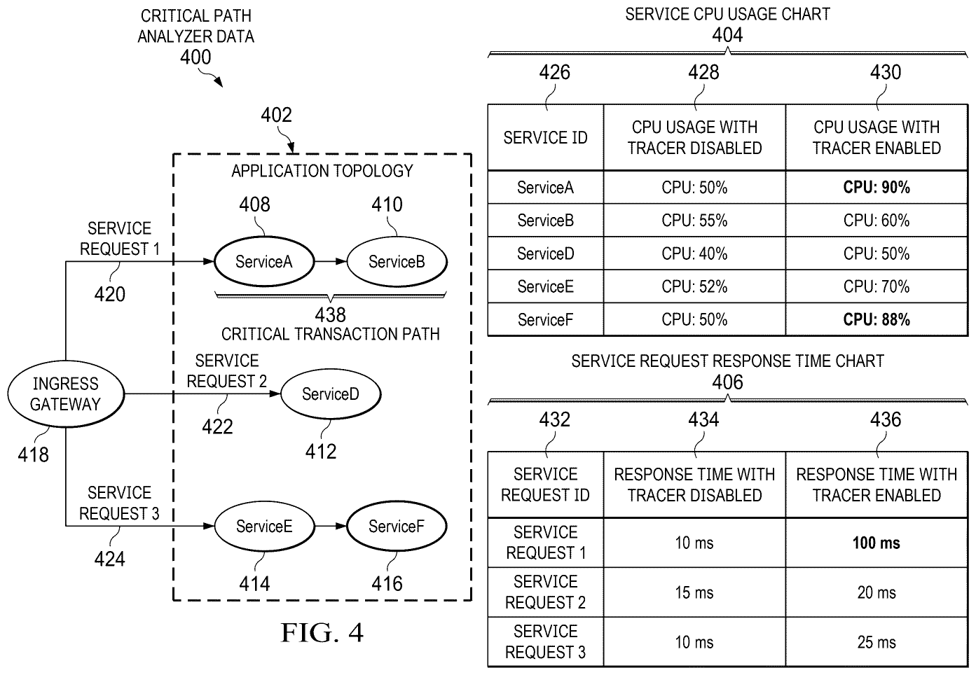

With reference now to FIG. 4, a diagram illustrating an example of critical path analyzer data is depicted in accordance with an illustrative embodiment. Critical path analyzer data 400 may be implemented in, for example, critical path analyzer 212 in FIG. 2B.

In this example, critical path analyzer data 400 includes application topology 402, service CPU usage chart 404, and service request response time chart 406. Application topology 402 includes service A 408, service B 410, service D 412, service E 414, and service F 416 corresponding to an application. In addition, service B 410 is dependent on service A 408 in one transaction path of the application and service F 416 is dependent on service E 414 in another transaction path of the application. However, it should be noted that application topology 402 is intended as an example only and can include any number of services and service dependencies.

Ingress gateway 418, such as ingress gateway 208 in FIG. 2A, sends service request 1 420 to service A 408, service request 2 422 to service D 412, and service request 3 424 to service E 414. Service CPU usage chart 404 includes service identifier (ID) 426, CPU usage with tracer disabled 428, and CPU usage with tracer enabled 430. Service request response time chart 406 includes service request ID 432, response time with tracer disabled 434, and response time with tracer enabled 436.

The critical path analyzer identifies one or more services having the highest CPU usage based on the information contained in service CPU usage chart 404. In this example, the CPU usage of service A 408 and service F 416 is greater than a predefined CPU usage threshold level. In this example, the predefined CPU usage threshold level is 80%. However, it should be noted that the predefined CPU usage threshold level can be set at any percentage, such as, for example, 70%, 75%, 80%, 85%, 90%, or the like.

In response to identifying services having CPU usage greater than the predefined CPU usage threshold level, the critical path analyzer analyzes service A 408 and service F 416 to determine which service is in a critical transaction path of the application. In this example, the critical path analyzer determines that service A 408 processing service request 1 420 is in critical transaction path 438, which includes service B 410, because service A 408 has the greatest CPU usage and response time when the tracer is enabled according to service CPU usage chart 404 and service requests response time chart 406.

However, it should be noted that the critical path analyzer can utilize different ways of identifying the set of services in the critical transaction path. For example, the critical path analyzer can first analyze the response time of each service request. If the response time increases to greater than a predefined response time threshold level when a set of services is processing a particular service request, then the critical path analyzer can identify the transaction path through the set of services corresponding to that particular service request. After identifying the transaction path, the critical path analyzer can analyze the change in the CPU usage of the set of services in that transaction path to determine if that transaction path is a critical transaction path. As a result, illustrative embodiments are not dependent on CPU usage only for determining critical transaction paths.

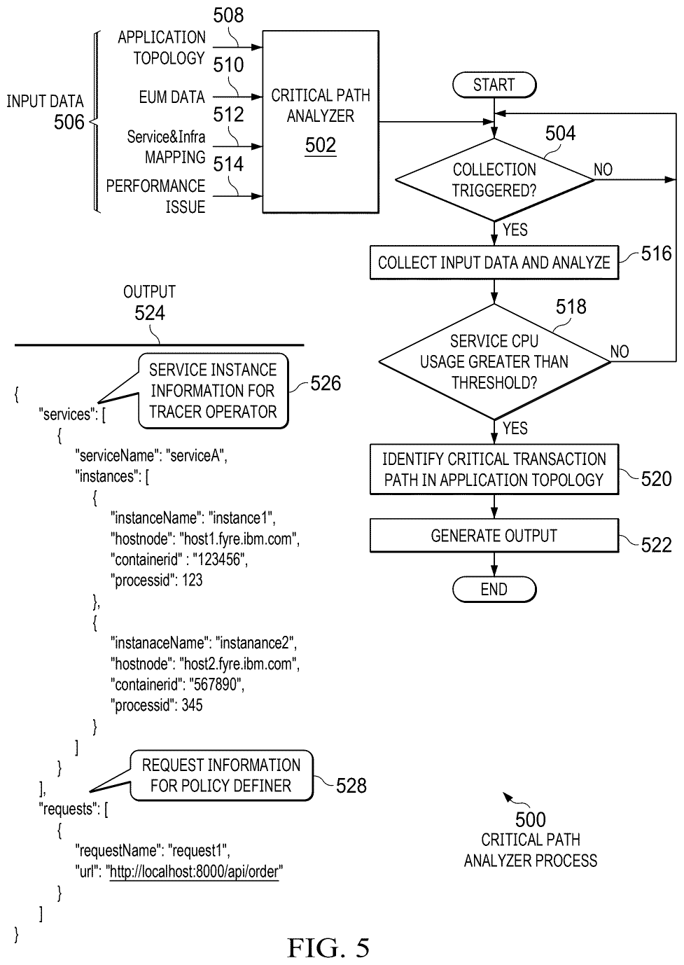

With reference now to FIG. 5, a diagram illustrating an example of a critical path analyzer process is depicted in accordance with an illustrative embodiment. Critical path analyzer process 500 is implemented in critical path analyzer 502.

At 504, critical path analyzer 502 determines whether collection of input data 506 is triggered. Input data 506 includes application topology 508, end user monitoring (EUM) data 510, service and infrastructure mapping data 512, and performance issue data 514.

At 516, in response to determining that collection of input data 506 is triggered based on receiving a request from a user to analyze tracer performance impact on an application, critical path analyzer 502 collects and analyzes input data 506. At 518, critical path analyzer 502 determines whether a service of the application has a CPU usage greater than a defined CPU usage threshold level.

At 520, in response to critical path analyzer 502 determining that a service of the application does have a CPU usage greater than the defined CPU usage threshold level, critical path analyzer 502 identifies a critical transaction path in the topology of the application that includes the service having the CPU usage greater than the defined CPU usage threshold level. The critical transaction path in the topology of the application may be, for example, critical transaction path 438 in application topology 402 in FIG. 4. At 522, critical path analyzer 502 generates output 524. In this example, output 524 includes information 526 and information 528.

Information 526 represents service instance information (e.g., identifying service A instance 1 and service A instance 2, such as service A instance 1 220 and service A instance 2 222 in FIG. 2A), for a tracer operator, such as tracer operator 224 in FIG. 2A. Information 528 represents request information (e.g., identifying a tracer performance impact analysis request) for a policy definer, such as policy definer 260 in FIG. 2A.

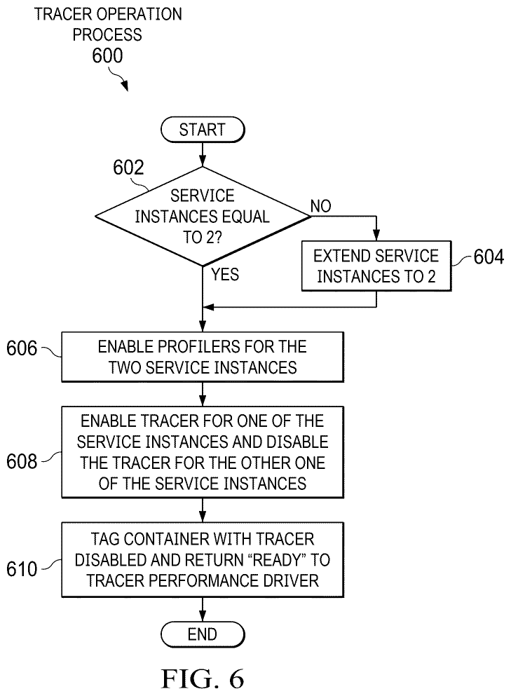

With reference now to FIG. 6, a diagram illustrating an example of a tracer operator process is depicted in accordance with an illustrative embodiment. Tracer operator process 600 is implemented in, for example, tracer operator 224 in FIG. 2A.

At 602, the tracer operator determines whether a number of service instances (e.g., service A instance 1 220 and service A instance 2 222 in FIG. 2A) is equal to two. At 604, in response to determining that the number of service instances is not equal to two (e.g., equal to one), the tracer operator extends the number of service instances to two. At 606, in response to determining that the number of service instances is equal to two, the tracer operator enables the tracer (e.g., tracer 242 in FIG. 2A) for one of the service instances (e.g., service A instance 1 220 in FIG. 2A) and disables the tracer for the other service instance (e.g., service A instance 2 222 in FIG. 2A). In addition, the tracer operator turns on the profilers (e.g., profiler 250 and profiler 252 in FIG. 2A) for the two different service instances. At 610, the tracer operator tags the container running the service instance with the tracer disabled with a label of “notracer=true” and tags the container running the service instance with the tracer enabled with a label of “tracer=true”. Further, the tracer operator returns a “ready” signal to a tracer performance driver (e.g., tracer performance driver 210 in FIG. 2B).

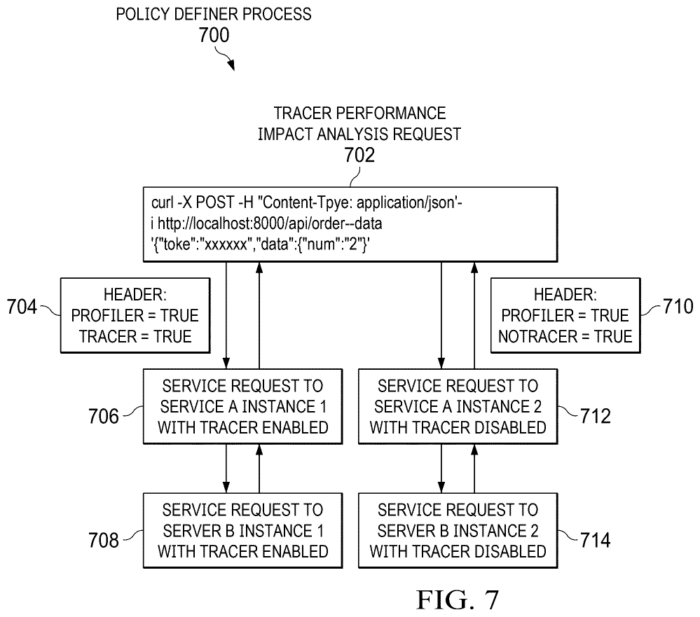

With reference now to FIG. 7, a diagram illustrating an example of a policy definer process is depicted in accordance with an illustrative embodiment. Policy definer process 700 is implemented in, for example, policy definer 260 in FIG. 2A.

The policy definer generates rules to dispatch service requests equally to the two service instances of the application in response to receiving tracer performance impact analysis request 702. The policy definer dispatches the service requests equally among the service instances to ensure that the service instance with the tracer enabled and the service instance with the tracer disabled are processing the same workload. For example, the policy definer sends service requests with header 704 indicating “profiler=true” and “tracer=true” to service A instance 1 with tracer enabled 706 and service B instance 1 with tracer disabled 708. In addition, the policy definer sends service requests with header 710 indicating “profiler=true” and “notracer=true” to service A instance 2 with tracer enabled 712 and service B instance 2 with tracer disabled 714.

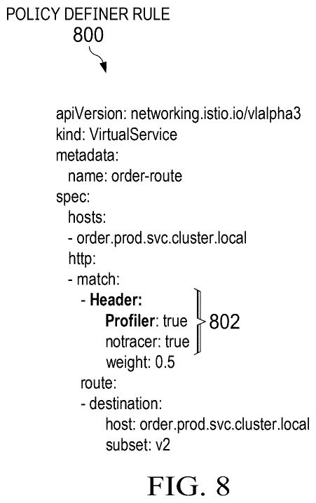

With reference now to FIG. 8, a diagram illustrating an example of a policy definer rule is depicted in accordance with an illustrative embodiment. Policy definer rule 800 is implemented in, for example, policy definer 260 in FIG. 2A. Policy definer rule 800 includes header 802. Header 802 is similar to header 710 in FIG. 7. The policy definer matches policy definer rule 800 to corresponding host nodes (e.g., host node 1 204 and host node 2 206 in FIG. 2A) and dispatches the service requests equally to the service instance with the tracer enabled and the service instance with the tracer disabled.

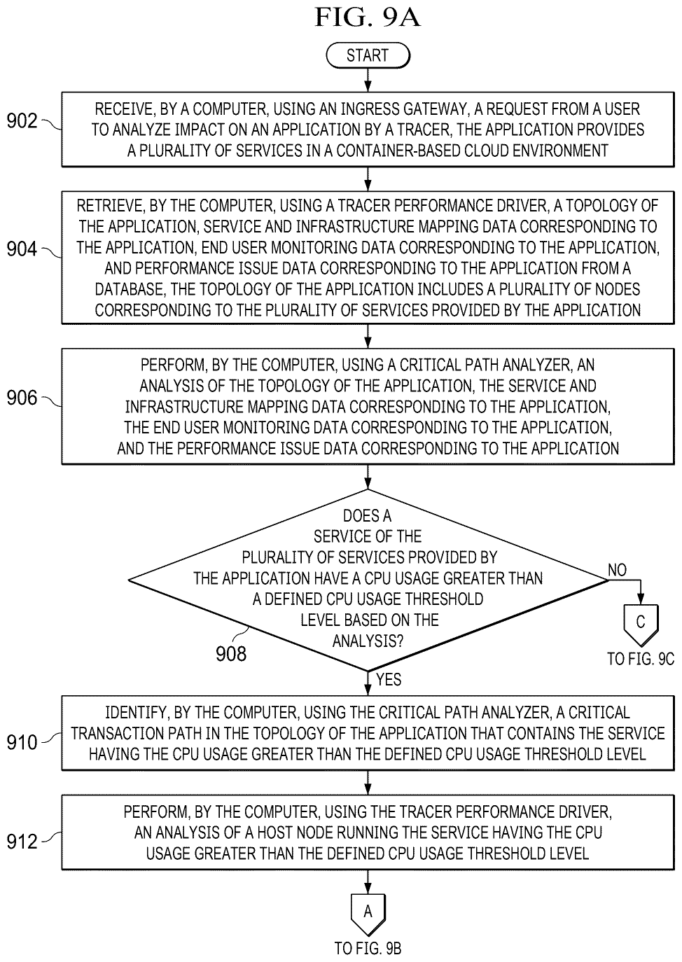

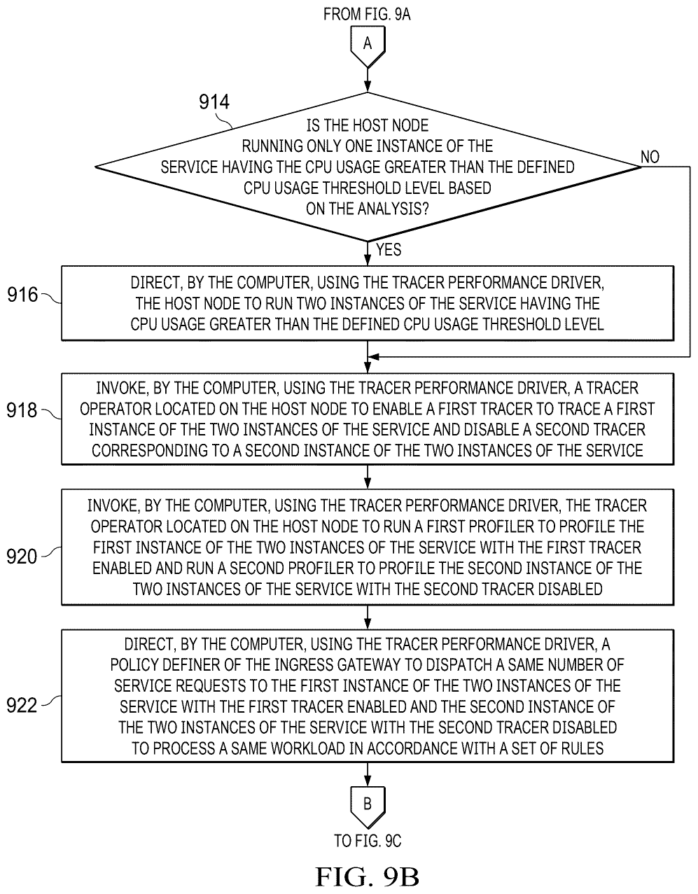

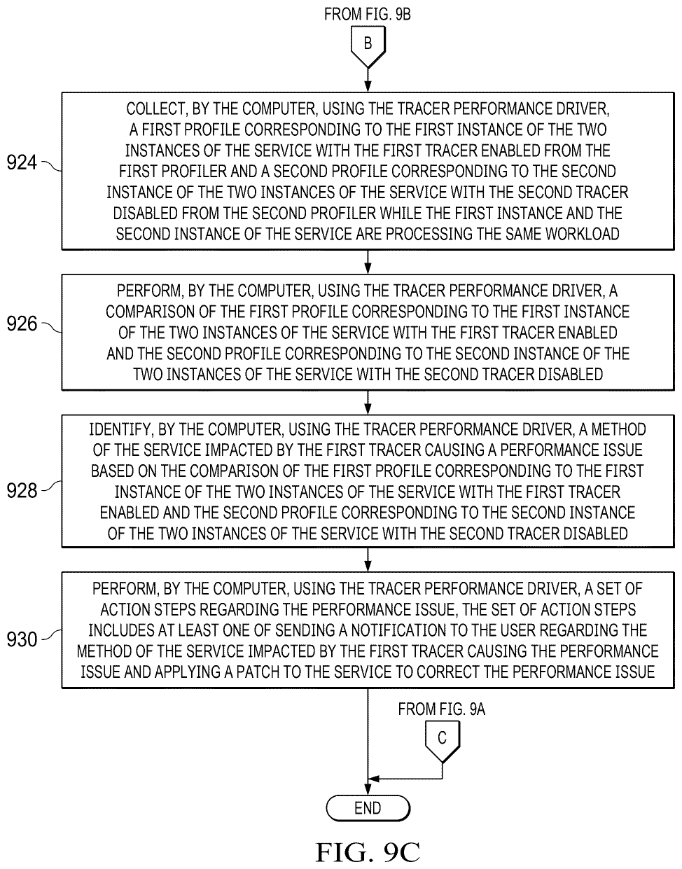

With reference now to FIGS. 9A-9C, a flowchart illustrating a process for analyzing tracer impact on applications is shown in accordance with an illustrative embodiment. The process shown in FIGS. 9A-9C may be implemented in a computer, such as, for example, computer 101 in FIG. 1. For example, the process shown in FIGS. 9A-9C may be implemented by tracer performance impact analysis code 200 in FIG. 1.

The process begins when the computer, using an ingress gateway, receives a request from a user to analyze impact on an application by a tracer (step 902). The application provides a plurality of services in a container-based cloud environment. The plurality of services run on a plurality of host nodes in the container-based cloud environment.

In response to receiving the request to analyze the impact on the application by the tracer, the computer, using a tracer performance driver, retrieves a topology of the application, service and infrastructure mapping data corresponding to the application, end user monitoring data corresponding to the application, and performance issue data corresponding to the application from a database (step 904). The topology of the application includes a plurality of nodes corresponding to the plurality of services provided by the application. The computer, using a critical path analyzer, performs an analysis of the topology of the application, the service and infrastructure mapping data corresponding to the application, the end user monitoring data corresponding to the application, and the performance issue data corresponding to the application (step 906).

The computer makes a determination as to whether a service of the plurality of services provided by the application has a CPU usage greater than a defined CPU usage threshold level based on the analysis (step 908). If the computer determines that a service of the plurality of services provided by the application does not have a CPU usage greater than the defined CPU usage threshold level based on the analysis, no output of step 908, then the process terminates thereafter. If the computer determines that a service of the plurality of services provided by the application does have a CPU usage greater than the defined CPU usage threshold level based on the analysis, yes output of step 908, then the computer, using the critical path analyzer, identifies a critical transaction path in the topology of the application that contains the service having the CPU usage greater than the defined CPU usage threshold level (step 910).

Afterward, the computer, using the tracer performance driver, performs an analysis of a host node running the service having the CPU usage greater than the defined CPU usage threshold level (step 912). In addition, the computer makes a determination as to whether the host node is running only one instance of the service having the CPU usage greater than the defined CPU usage threshold level based on the analysis (step 914). If the computer determines that the host node is running only one instance of the service having the CPU usage greater than the defined CPU usage threshold level based on the analysis, yes output of step 914, then the computer, using the tracer performance driver, directs the host node to run two instances of the service having the CPU usage greater than the defined CPU usage threshold level (step 916). Thereafter, the process proceeds to step 918. If the computer determines that the host node is running two instances of the service having the CPU usage greater than the defined CPU usage threshold level based on the analysis, no output of step 914, then the computer, using the tracer performance driver, invokes a tracer operator located on the host node to enable a first tracer to trace a first instance of the two instances of the service and disable a second tracer corresponding to a second instance of the two instances of the service (step 918).

Further, the computer, using the tracer performance driver, invokes the tracer operator located on the host node to run a first profiler to profile the first instance of the two instances of the service with the first tracer enabled and run a second profiler to profile the second instance of the two instances of the service with the second tracer disabled (step 920). Furthermore, the computer, using the tracer performance driver, directs a policy definer of the ingress gateway to dispatch a same number of service requests to the first instance of the two instances of the service with the first tracer enabled and the second instance of the two instances of the service with the second tracer disabled to process a same workload in accordance with a set of rules (step 922).

Subsequently, the computer, using the tracer performance driver, collects a first profile corresponding to the first instance of the two instances of the service with the first tracer enabled from the first profiler and a second profile corresponding to the second instance of the two instances of the service with the second tracer disabled from the second profiler while the first instance and the second instance of the service are processing the same workload (step 924). Then, the computer, using the tracer performance driver, performs a comparison of the first profile corresponding to the first instance of the two instances of the service with the first tracer enabled and the second profile corresponding to the second instance of the two instances of the service with the second tracer disabled (step 926).

The computer, using the tracer performance driver, identifies a method (e.g., a process) of the service impacted by the first tracer causing a performance issue based on the comparison of the first profile corresponding to the first instance of the two instances of the service with the first tracer enabled and the second profile corresponding to the second instance of the two instances of the service with the second tracer disabled (step 928). In response to identifying the method of the service impacted by the first tracer causing a performance issue, the computer, using the tracer performance driver, performs a set of action steps regarding the performance issue (step 930). The set of action steps includes at least one of sending a notification to the user regarding the method of the service impacted by the first tracer causing the performance issue and applying a patch to the service to correct the performance issue. Thereafter, the process terminates.

Thus, illustrative embodiments of the present disclosure provide a computer-implemented method, computer system, and computer program product for identifying a performance issue in a service of an application caused by a tracer running in the application. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing a comparison of a first profile corresponding to a first instance of two instances of a service with a first tracer enabled and a second profile corresponding to a second instance of the two instances of the service with a second tracer disabled; and
identifying a method of the service impacted by the first tracer causing a performance issue based on the comparison of the first profile corresponding to the first instance of the two instances of the service with the first tracer enabled and the second profile corresponding to the second instance of the two instances of the service with the second tracer disabled.

2. The method of claim 1, further comprising:
receiving a request from a user to analyze impact on an application by a tracer, the application provides a plurality of services in a container-based cloud environment and the plurality of services run on a plurality of host nodes in the container-based cloud environment;
retrieving a topology of the application, service and infrastructure mapping data corresponding to the application, end user monitoring data corresponding to the application, and performance issue data corresponding to the application in response to receiving the request from the user to analyze the impact on the application by the tracer; and
performing an analysis of the topology of the application, the service and infrastructure mapping data corresponding to the application, the end user monitoring data corresponding to the application, and the performance issue data corresponding to the application.

3. The method of claim 2, further comprising:
determining whether the service of the plurality of services provided by the application has a CPU usage greater than a defined CPU usage threshold level based on the analysis of the topology of the application, the service and infrastructure mapping data corresponding to the application, the end user monitoring data corresponding to the application, and the performance issue data corresponding to the application; and
responsive to determining that the service of the plurality of services provided by the application does have the CPU usage greater than the defined CPU usage threshold level based on the analysis, identifying a critical transaction path in the topology of the application that contains the service having the CPU usage greater than the defined CPU usage threshold level.

4. The method of claim 3, further comprising:
performing an analysis of a host node running the service having the CPU usage greater than the defined CPU usage threshold level;
determining whether the host node is running only one instance of the service having the CPU usage greater than the defined CPU usage threshold level based on the analysis of the host node; and
responsive to determining that the host node is running only one instance of the service having the CPU usage greater than the defined CPU usage threshold level based on the analysis of the host node, directing the host node to run the two instances of the service having the CPU usage greater than the defined CPU usage threshold level.

5. The method of claim 4, further comprising:
responsive to determining that the host node is running the two instances of the service having the CPU usage greater than the defined CPU usage threshold level based on the analysis of the host node, invoking a tracer operator located on the host node to enable the first tracer to trace the first instance of the two instances of the service and disable the second tracer corresponding to the second instance of the two instances of the service; and
invoking the tracer operator located on the host node to run a first profiler to profile the first instance of the two instances of the service with the first tracer enabled and run a second profiler to profile the second instance of the two instances of the service with the second tracer disabled.

6. The method of claim 5, further comprising:
directing a policy definer to dispatch a same number of service requests to the first instance of the two instances of the service with the first tracer enabled and the second instance of the two instances of the service with the second tracer disabled to process a same workload in accordance with a set of rules; and
collecting the first profile corresponding to the first instance of the two instances of the service with the first tracer enabled from the first profiler and the second profile corresponding to the second instance of the two instances of the service with the second tracer disabled from the second profiler while the first instance and the second instance of the service are processing the same workload.

7. The method of claim 1, further comprising:
performing a set of action steps regarding the performance issue in response to identifying the method of the service impacted by the first tracer causing the performance issue, the set of action steps includes at least one of sending a notification to a user regarding the method of the service impacted by the first tracer causing the performance issue and applying a patch to the service to correct the performance issue.

8. A computer system comprising:
a processor set;
one or more computer-readable storage media; and
program instructions stored on the one or more computer-readable storage media to cause the processor set to perform operations comprising:
performing a comparison of a first profile corresponding to a first instance of two instances of a service with a first tracer enabled and a second profile corresponding to a second instance of the two instances of the service with a second tracer disabled; and
identifying a method of the service impacted by the first tracer causing a performance issue based on the comparison of the first profile corresponding to the first instance of the two instances of the service with the first tracer enabled and the second profile corresponding to the second instance of the two instances of the service with the second tracer disabled.

9. The computer system of claim 8, wherein the operations further comprise:
receiving a request from a user to analyze impact on an application by a tracer, the application provides a plurality of services in a container-based cloud environment and the plurality of services run on a plurality of host nodes in the container-based cloud environment;
retrieving a topology of the application, service and infrastructure mapping data corresponding to the application, end user monitoring data corresponding to the application, and performance issue data corresponding to the application in response to receiving the request from the user to analyze the impact on the application by the tracer; and
performing an analysis of the topology of the application, the service and infrastructure mapping data corresponding to the application, the end user monitoring data corresponding to the application, and the performance issue data corresponding to the application.

10. The computer system of claim 9, wherein the operations further comprise:
determining whether the service of the plurality of services provided by the application has a CPU usage greater than a defined CPU usage threshold level based on the analysis of the topology of the application, the service and infrastructure mapping data corresponding to the application, the end user monitoring data corresponding to the application, and the performance issue data corresponding to the application; and
responsive to determining that the service of the plurality of services provided by the application does have the CPU usage greater than the defined CPU usage threshold level based on the analysis, identifying a critical transaction path in the topology of the application that contains the service having the CPU usage greater than the defined CPU usage threshold level.

11. The computer system of claim 10, wherein the operations further comprise:
performing an analysis of a host node running the service having the CPU usage greater than the defined CPU usage threshold level;
determining whether the host node is running only one instance of the service having the CPU usage greater than the defined CPU usage threshold level based on the analysis of the host node; and
responsive to determining that the host node is running only one instance of the service having the CPU usage greater than the defined CPU usage threshold level based on the analysis of the host node, directing the host node to run the two instances of the service having the CPU usage greater than the defined CPU usage threshold level.

12. The computer system of claim 11, wherein the operations further comprise:
responsive to determining that the host node is running the two instances of the service having the CPU usage greater than the defined CPU usage threshold level based on the analysis of the host node, invoking a tracer operator located on the host node to enable the first tracer to trace the first instance of the two instances of the service and disable the second tracer corresponding to the second instance of the two instances of the service; and
invoking the tracer operator located on the host node to run a first profiler to profile the first instance of the two instances of the service with the first tracer enabled and run a second profiler to profile the second instance of the two instances of the service with the second tracer disabled.

13. The computer system of claim 12, wherein the operations further comprise:
directing a policy definer to dispatch a same number of service requests to the first instance of the two instances of the service with the first tracer enabled and the second instance of the two instances of the service with the second tracer disabled to process a same workload in accordance with a set of rules; and
collecting the first profile corresponding to the first instance of the two instances of the service with the first tracer enabled from the first profiler and the second profile corresponding to the second instance of the two instances of the service with the second tracer disabled from the second profiler while the first instance and the second instance of the service are processing the same workload.

14. A computer program product comprising:
one or more computer-readable storage media; and
program instructions stored on the one or more computer-readable storage media to perform operations comprising:
performing a comparison of a first profile corresponding to a first instance of two instances of a service with a first tracer enabled and a second profile corresponding to a second instance of the two instances of the service with a second tracer disabled; and
identifying a method of the service impacted by the first tracer causing a performance issue based on the comparison of the first profile corresponding to the first instance of the two instances of the service with the first tracer enabled and the second profile corresponding to the second instance of the two instances of the service with the second tracer disabled.

15. The computer program product of claim 14, wherein the operations further comprise:
receiving a request from a user to analyze impact on an application by a tracer, the application provides a plurality of services in a container-based cloud environment and the plurality of services run on a plurality of host nodes in the container-based cloud environment;
retrieving a topology of the application, service and infrastructure mapping data corresponding to the application, end user monitoring data corresponding to the application, and performance issue data corresponding to the application in response to receiving the request from the user to analyze the impact on the application by the tracer; and
performing an analysis of the topology of the application, the service and infrastructure mapping data corresponding to the application, the end user monitoring data corresponding to the application, and the performance issue data corresponding to the application.

16. The computer program product of claim 15, wherein the operations further comprise:
determining whether the service of the plurality of services provided by the application has a CPU usage greater than a defined CPU usage threshold level based on the analysis of the topology of the application, the service and infrastructure mapping data corresponding to the application, the end user monitoring data corresponding to the application, and the performance issue data corresponding to the application; and
responsive to determining that the service of the plurality of services provided by the application does have the CPU usage greater than the defined CPU usage threshold level based on the analysis, identifying a critical transaction path in the topology of the application that contains the service having the CPU usage greater than the defined CPU usage threshold level.

17. The computer program product of claim 16, wherein the operations further comprise:
performing an analysis of a host node running the service having the CPU usage greater than the defined CPU usage threshold level;
determining whether the host node is running only one instance of the service having the CPU usage greater than the defined CPU usage threshold level based on the analysis of the host node; and
responsive to determining that the host node is running only one instance of the service having the CPU usage greater than the defined CPU usage threshold level based on the analysis of the host node, directing the host node to run the two instances of the service having the CPU usage greater than the defined CPU usage threshold level.

18. The computer program product of claim 17, wherein the operations further comprise:
responsive to determining that the host node is running the two instances of the service having the CPU usage greater than the defined CPU usage threshold level based on the analysis of the host node, invoking a tracer operator located on the host node to enable the first tracer to trace the first instance of the two instances of the service and disable the second tracer corresponding to the second instance of the two instances of the service; and
invoking the tracer operator located on the host node to run a first profiler to profile the first instance of the two instances of the service with the first tracer enabled and run a second profiler to profile the second instance of the two instances of the service with the second tracer disabled.

19. The computer program product of claim 18, wherein the operations further comprise:
directing a policy definer to dispatch a same number of service requests to the first instance of the two instances of the service with the first tracer enabled and the second instance of the two instances of the service with the second tracer disabled to process a same workload in accordance with a set of rules; and
collecting the first profile corresponding to the first instance of the two instances of the service with the first tracer enabled from the first profiler and the second profile corresponding to the second instance of the two instances of the service with the second tracer disabled from the second profiler while the first instance and the second instance of the service are processing the same workload.

20. The computer program product of claim 14, wherein the operations further comprise:
performing a set of action steps regarding the performance issue in response to identifying the method of the service impacted by the first tracer causing the performance issue, the set of action steps includes at least one of sending a notification to a user regarding the method of the service impacted by the first tracer causing the performance issue and applying a patch to the service to correct the performance issue.
